(19) United States
(12) Patent Application Publication
(10) Pub. No.: US 2007/0212195 A1
(43) Pub. Date: Sep. 13, 2007

(54) Lifting Bolt Comprising Safety Element

(76) Inventors: Reinhard Smetz, Ottingen (DE); Michael Betzler, Aalen (DE)

Correspondence Address: Mark P Stone, 4th Floor, 25 Third Street, Stamford, CT, 06905, US

(21) Appl. No.: 11/547,732

(22) PCT Filed: Apr. 14, 2005
(86) PCT No.: PCT/EP05/03904

§ 371 Date: Oct. 6, 2006

(30) Foreign Application Priority Data
Apr. 21, 2004 (DE) 10 2004 020 039.4

(51) Int. Cl. F16B 35/00

(52) U.S. Cl. 411/379

(57) ABSTRACT

In the technical field, so-called lifting points are used to link chains, ropes or straps with objects. These lifting points often are configured as shackles, i.e. they have two limbs (1, 2) the space (5) between which is bridged by a lifting bolt (4). In order to keep the lifting bolt (4) in its position, a captivated safety element is used which comprises a locking pin (7) received in a cross-bore (10) of the lifting bolt (4). Said locking pin (7) can be transferred, against the action of a spring (8), from a safety position to a release position by means of an actuating pin (9) guided in a longitudinal bore (11) of the lifting bolt (4).

### TECHNICAL FIELD

The invention relates to a supporting bolt which serves to bridge an interspace between two side members of a load-lifting device and which, apart from a fixed end stop, has a captive locking element, which can assume a locking position and a release position.

### PRIOR ART

Lifting bolts of the above-described type are particularly used in connection with attachment points for chains, ropes or belts, as these are encountered, for example, in large forming tools as integrated components of these tools.

From draft VDI 3366 of the VDI guidelines, a lifting bolt of the generic type in question is known, which is provided with a so-called drop-ring locking mechanism. Such a locking mechanism offers the advantage, compared to locking mechanisms in the form of cotter pins which can be introduced into bores at the ends of the lifting bolt or in the form of locking pins which can be hammered into transverse bores in the cheeks, that the locking element is captive, in addition to which, in these locking mechanisms, the ease of operation requirement cannot be satisfied, since the drop-ring, at least in the removal of the lifting bolt prior to the penetration of the bores in the side members of the load-lifting device, has to be manually removed from its locking position, which, in practice, frequently results in finger injuries for the operator. Since the known locking mechanism is based on the gravity principle, it is also susceptible to dirt contamination.

### SUMMARY OF THE INVENTION

The object of the invention is to provide a lifting bolt which is convenient to use and offers a high degree of safety. This object is achieved according to the invention by the fact that the lifting bolt is provided with a transverse bore and a longitudinal bore which intersects the transverse bore and that in the transverse bore there are disposed a blocking bolt and a spring which forces the blocking bolt into the blocking position, while in the longitudinal bore an actuating bolt for the blocking bolt is guided, the blocking bolt having a recess with an oblique face, via which, by a portion of the actuating bolt which is guided in the recess, a motion which is contrary to the spring force and removes the blocking bolt from its locking position can be transmitted to the blocking bolt.

The lifting bolt according to the invention offers the advantage that it can be both fitted and removed rapidly and without problems. Impairments of the locking mechanism as a result of dirt contamination are not to be feared, since all functionally important parts are disposed inside the lifting bolt.

Further features and details of the invention emerge from the subclaims and the following description of a particularly advantageous embodiment of the invention, represented in the appended drawings.

### BRIEF DESCRIPTION OF THE DRAWINGS

FIG. 1 shows the front view of a so-called lifting cheek, the interspace of which, limited by side members, is bridged by a lifting bolt,

FIG. 2 shows a section along the line II-II in FIG. 1,

FIG. 3 shows a section along the line III-III in FIG. 1,

FIG. 4 shows a detail IV in FIG. 3 on an enlarged scale,

FIG. 5 shows a detail V in FIG. 2 on an enlarged scale,

FIG. 6 shows a first perspective representation of the parts of the locking mechanism of the lifting bolt,

FIG. 7 shows a second perspective representation of the parts of the locking mechanism of the lifting bolt,

FIG. 8 shows a section through the lifting bolt according to FIGS. 1 to 7 in the locking position, on an enlarged scale relative to FIG. 3,

FIG. 9 shows a section through the lifting bolt according to FIGS. 1 to 7 in the unlocked position, on an enlarged scale relative to FIG. 3, and

FIG. 10 shows a section through the lifting bolt according to FIGS. 1 to 7 during the fitting or removal of the parts forming the locking mechanism, on an enlarged scale relative to FIG. 3.

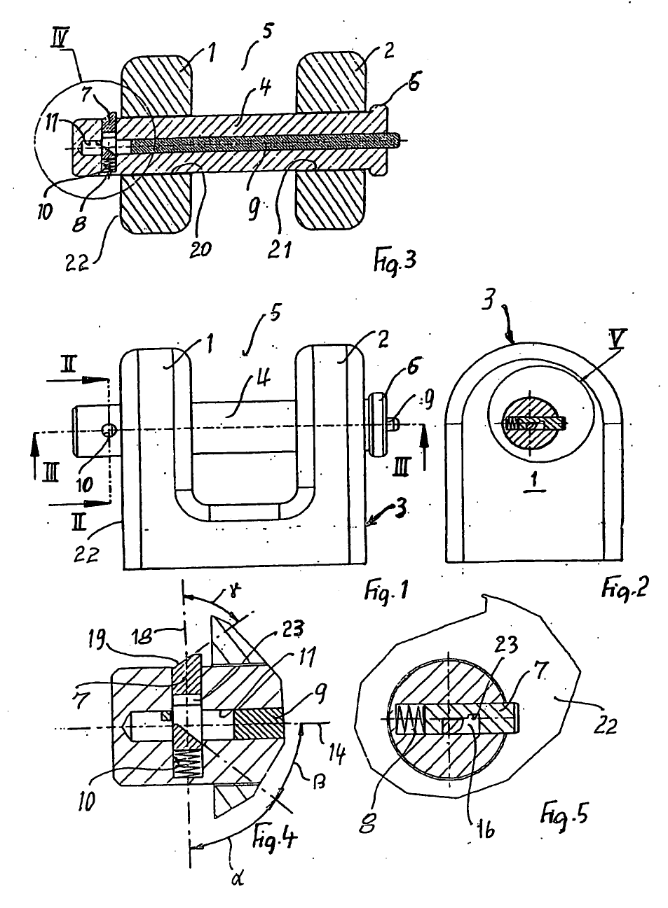

### WAYS TO IMPLEMENT THE INVENTION

In the figures, 1 and 2 are the side members of a load-lifting device formed by a so-called lifting cheek 3.

The side members 1 and 2 limit an interspace 5 bridged by a lifting bolt 4, which can be put through an end member (not represented) of a sling chain strand or through the thimble of a hoisting rope.

In order to ensure that the lifting bolt 4 does not inadvertently work loose when a load to which the lifting cheek 3 is bolted or welded is hoisted, it is provided with a position-locking mechanism. This comprises, on the one hand, an end stop 6 formed by an annular flange and, on the other hand, a blocking bolt 7, which is forced by a spring 8 into a blocking position from which it can be removed with the aid of an actuating bolt 9. The blocking bolt 7 and the spring 8 are accommodated in a transverse bore 10, which intersects a longitudinal bore 11 in which the actuating bolt 9 is guided.

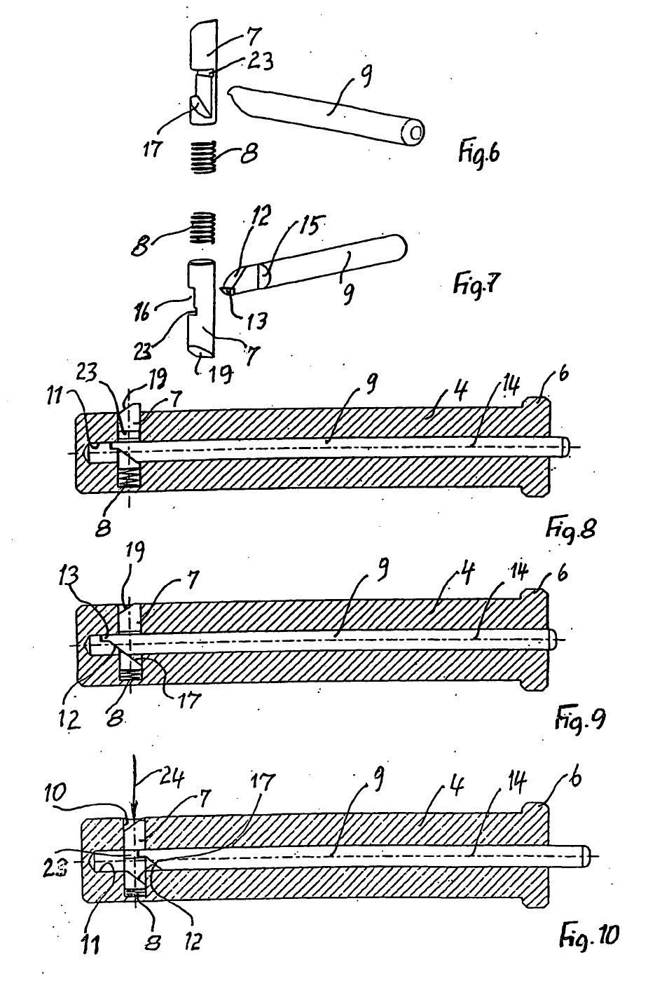

As can be seen, in particular, from FIGS. 6 and 7, the actuating bolt 9 possesses on its free end an oblique face 12, adjoined by a latch cam 13, which in the assembled state of the actuating bolt 9 back-grips the blocking bolt 7 in order thereby to secure the holding-together of the actuating bolt 9 and the blocking bolt 7. A stop face 15 running perpendicular to the longitudinal axis 14 of the actuating bolt 9 limits the lift of the actuating bolt 9.

That end of the actuating bolt 9 which has the latch cam 13 engages in a recess 16 in the blocking bolt 7, which recess has an oblique face 17 designed to cooperate with the oblique face 12 of the actuating bolt 9.

The oblique face 17 of the blocking bolt 7 forms an angle α of about 50° to the longitudinal axis 18 of the blocking bolt 7, while the angle β between the oblique face 12 of the actuating bolt 9 and its longitudinal axis 14 measures about 40°. At its end which, in the blocking position, projects over the periphery of the lifting bolt 4, the blocking bolt 7 is equipped with a further oblique face 19, which forms an angle γ of about 60° to the longitudinal axis 18 of the blocking bolt 7.

By virtue of the oblique face 19 and the nature of the assignment of the actuating bolt 9 to the blocking bolt 7, the latter, when the lifting bolt 4 is introduced into the aligned bores 20 and 21 in the side members 1 and 2 of the lifting cheek 3, is automatically transferred into the position represented in FIG. 9. As soon as the blocking bolt 7 has passed through the front wall 22 of the side member 1, the end of the blocking bolt 7 is moved back by the spring 8 into the position represented in FIG. 8, so that the lifting bolt 4 is held securely in the lifting cheek 3.

In order to be able to easily fit and remove the parts 7, 8 and 9 of the locking mechanism, the blocking bolt 7 is provided with an insert groove 23, through which the latch cam 13 can pass when the blocking bolt 7, for example with the aid of a pencil or spike, is forced in the direction of the arrow 24 counter to the action of the spring 8 into the position represented in FIG. 10.

1. A lifting bolt (4) which serves to bridge an interspace between two side members (1, 2) of a load- lifting device and which, apart from a fixed end stop (6), has a captive locking element (7), which can assume a locking position and a release position, characterized in that the lifting bolt (4) is provided with a transverse bore (10) and a longitudinal bore (11) which intersects the transverse bore (10) and in that in the transverse bore (10) there are disposed a blocking bolt (7) and a spring (8) which forces the blocking bolt (7) into the locking position, while in the longitudinal bore (11) an actuating bolt (9) for the blocking bolt (7) is guided, the blocking bolt (7) having a recess (16) with an oblique face (17), via which, by a portion of the actuating bolt (9) which is guided in the recess (16), a motion which is contrary to the spring force and removes the blocking bolt (7) from its locking position can be transmitted to the blocking bolt (7).

2. The lifting bolt as claimed in claim 1, characterized in that the recess (16) in the blocking bolt (7) is provided at its end opposite the oblique face (17) with an insert groove (23) for a latch cam (13), which latch cam back-grips the blocking bolt (7) in its operating positions and is disposed at the end of the actuating bolt (9).

3. The lifting bolt as claimed in claim 1, characterized in that the blocking bolt (7), for the transfer of the latch cam (13) of the actuating bolt (9) into the region of the insert groove (23) counter to the action of the spring (8) disposed at the end of the bore (10) for the blocking bolt (7), can be forced into this bore (10).

4. The lifting bolt as claimed in claim 1, characterized in that the actuating bolt (9) is provided with a stop face (15), which limits the lift of the actuating bolt (9).

5. The lifting bolt as claimed in claim 1, characterized in that that portion of the actuating bolt (9) which is guided in the recess (16) in the blocking bolt (7) is provided with an oblique face (12), the slope of which is matched to the slope of the oblique face (17) of the blocking bolt (7).

6. The lifting bolt as claimed in claim 5, characterized in that the oblique faces (17, 12) of the blocking bolt (7) and of the actuating bolt (9) are substantially semicircular.

7. The lifting bolt as claimed in claim 1, characterized in that the oblique face (17) of the blocking bolt (7) forms an angle (α) of 50° to its longitudinal axis (18).

8. The lifting bolt as claimed in claim 1, characterized in that the oblique face (12) of the actuating bolt (9) forms an angle (β) of 40° to its longitudinal axis (14).

9. The lifting bolt as claimed in claim 1, characterized in that the longitudinal axis (14) of the bore (11) for the actuating bolt (9) runs substantially perpendicular to the longitudinal axis (18) of the bore (10) for the blocking bolt (7).

10. The lifting bolt as claimed in claim 1, characterized in that the free end of the blocking bolt (7) is provided with an oblique face (19), via which, when the lifting bolt (4) is introduced into bores (20, 21) in the side members (1, 2) of the load-lifting device (3), a force which forces the blocking bolt (7) out of its locking position can be transmitted to the blocking bolt (7).

11. The lifting bolt as claimed in claim 2, characterized in that the blocking bolt (7), for the transfer of the latch cam (13) of the actuating bolt (9) into the region of the insert groove (23) counter to the action of the spring (8) disposed at the end of the bore (10) for the blocking bolt (7), can be forced into this bore (10).

12. The lifting bolt as claimed in claim 11, characterized in that the actuating bolt (9) is provided with a stop face (15), which limits the lift of the actuating bolt (9).

13. The lifting bolt as claimed in claim 11, characterized in that that portion of the actuating bolt (9) which is guided in the recess (16) in the blocking bolt (7) is provided with an oblique face (12), the slope of which is matched to the slope of the oblique face (17) of the blocking bolt (7).

14. The lifting bolt as claimed in claim 2, characterized in that the actuating bolt (9) is provided with a stop face (15), which limits the lift of the actuating bolt (9).

15. The lifting bolt as claimed in claim 3, characterized in that the actuating bolt (9) is provided with a stop face (15), which limits the lift of the actuating bolt (9).

16. The lifting bolt as claimed in claim 2, characterized in that that portion of the actuating bolt (9) which is guided in the recess (16) in the blocking bolt (7) is provided with an oblique face (12), the slope of which is matched to the slope of the oblique face (17) of the blocking bolt (7).

17. The lifting bolt as claimed in claim 2, characterized in that the oblique face (17) of the blocking bolt (7) forms an angle (α) of 50° to its longitudinal axis (18).

18. The lifting bolt as claimed in claim 2, characterized in that the oblique face (12) of the actuating bolt (9) forms an angle (β) of 40° to its longitudinal axis (14).

19. The lifting bolt as claimed in claim 2, characterized in that the longitudinal axis (14) of the bore (11) for the actuating bolt (9) runs substantially perpendicular to the longitudinal axis (18) of the bore (10) for the blocking bolt (7).

20. The lifting bolt as claimed in claim 2, characterized in that the free end of the blocking bolt (7) is provided with an oblique face (19), via which, when the lifting bolt (4) is introduced into bores (20, 21) in the side members (1, 2) of the load-lifting device (3), a force which forces the blocking bolt (7) out of its locking position can be transmitted to the blocking bolt (7).
